(19) United States
(12) Patent Application Publication
(10) Pub. No.: US 2012/0177972 A1
(43) Pub. Date: Jul. 12, 2012

(54) BATTERY MODULE

(76) Inventors: Jian-Jang Lai, Taoyuan Hsien (TW); Ku-Yueh Chen, Taoyuan Hsien (TW); Meng-Shun Wu, Taoyan Hsien (TW)

(21) Appl. No.: 13/348,022

(22) Filed: Jan. 11, 2012

(30) Foreign Application Priority Data
Jan. 12, 2011 (TW) 100101057

(51) Int. Cl. H01M 10/50

(52) U.S. Cl. 429/120

(57) ABSTRACT

A battery module includes a housing, a plurality of thermally conductive plates, a plurality of flat cells and a fixing unit. The thermally conductive plates and the flat cells are received in the housing. At least one of the thermally conductive plates is received between two of the flat cells and contacts with at least one of the two of the flat cells. Each of the flat cells respectively has a cell body and at least an electrode connected to and extended from the cell body. The fixing unit is received in the housing, and the electrode is fixed on the fixing unit. The battery module is applied advantageously to integrate the thermal dissipation system with the fixing structure. Additionally, the particular configuration used herein is beneficial to reduce the risk of electrode breakage.

### CROSS REFERENCE TO RELATED APPLICATIONS

This Non-provisional application claims priority under 35 U.S.C. §119(a) on Patent Application No(s). 100101057 filed in Taiwan, Republic of China on Jan. 12, 2011, the entire contents of which are hereby incorporated by reference.

### BACKGROUND OF THE INVENTION

1. Field of Invention

The present invention relates to a battery module and, in particular, relates to a flat cell module.

2. Related Art

When a battery module is used, huge amounts of waste heat is generated during charging and discharging. The waste heat not only affects the operating efficiency of an apparatus but also results in the damage to it, especially when a plenty of the battery modules are assembled into a battery stack. Therefore, the thermal dissipation system of the battery module has been concerned all the time.

Conventionally, thermal dissipation is majorly achieved by arranging many channels communicating with each other in a battery module such that the waste heat can be carried out of the battery module by air convection. However, the channels of the thermal dissipation system are so complicated and numerous that the battery module is hardly maintained in a state of uniform temperature. It causes the temperature diversity in the battery module and diminishes its life time and the efficiency. Furthermore, in order to improve the efficiency of thermal dissipation, the channels occupy a large proportion of the interior space in the battery module, and needs many lock points and components for configuration. It not only reduces the utilization rate of the interior space but also increases the production costs.

There's doubt about the safety of the conventional battery modules as well. Specifically, it is because that the electrodes and the cell bodies of the cells of the battery module are fixed separately. When the battery module is impacted or vibrated, different vibration frequencies are generated between the electrodes and the cell bodies so as to form an external force pulling both sides of the electrodes and having potential capability to easily tear the electrodes apart and produces.

Hence, it has been an important issue to provide a battery module with increased utilization efficiency by increasing the efficiency of the thermal dissipation and reducing the total volume of the channels. Moreover, the battery module also has an improved cushioning capacity to prevent the breakage of the electrodes by redesigning the configuration.

### SUMMARY OF THE INVENTION

In view of the foregoing, the purpose of the present invention is to provide a battery module with increased utilization efficiency by increasing the efficiency of the thermal dissipation and reducing the total volume of the channels. Meanwhile, the battery module also has an improved cushioning capacity to prevent the breakage of the electrodes by its innovative configuration.

To achieve the above, a battery module in accordance with the present invention includes a housing, a plurality of thermally conductive plates, a plurality of flat cells and a fixing unit. The thermally conductive plates and flat cells are received in the housing. At least one of the thermally conductive plates is disposed between two of flat cells and contacts with at least one of the two of the flat cells. Each of the flat cells respectively has a cell body and at least an electrode connected to and extended from the cell body. The fixing unit is received in the housing, and the electrode is fixed on the fixing unit. In one embodiment of the present invention, the thermally conductive plates are disposed along a direction and a distance between two of the thermally conductive plates is at least greater than the thickness of the flat cell.

In one embodiment of the present invention, the other one of the two of the flat cells contacts with another thermally conductive plate.

In one embodiment of the present invention, a surface of the flat cell is fattened against the thermally conductive plates.

In one embodiment of the present invention, the electrodes between the fixing unit and the cell bodies are longer than distances between the fixing unit and the cell bodies. Preferably, the extra parts of the electrodes with respect to the distances form wave shape or bending feature.

In one embodiment of the present invention, the electrodes are passed through the fixing unit from one side of the fixing unit adjacent to the cell bodies and then fixed on the other side of the fixing unit with respect to the cell bodies.

In one embodiment of the present invention, the fixing unit comprises at least an electrically conductive material and the electrodes are fixed on the fixing unit by being fixed on the electrically conductive materials.

In one embodiment of the present invention, the housing has at least an inlet and an outlet and an air flow flows through the battery module from the inlet to the outlet.

In one embodiment of the present invention, the battery module further includes at least a thermally conductive cylinder receiving heat from the flat cells to the thermally conductive plates.

In one embodiment of the present invention, the battery module further includes at least a thermal exchange plate disposed along a vertical direction of the thermally conductive plates and contacting with the thermally conductive cylinder such that the one of the flat cells, one of the thermally conductive plate and the thermally exchange plate form a sandwich assembly. Preferably, the battery module includes two of the thermal exchange plates disposed at two opposite sides of the thermally conductive plates along the direction. Additionally, the housing has at least an inlet and an outlet and an air flow passes through the thermal exchange plates when passing through the battery module from the inlet to the outlet.

In one embodiment of the present invention, the battery module further includes a base on which the thermal exchange plate is fixed. Preferably, the thermally conductive plates, the heat exchange plates and the fixing unit and the base are fixed together to integrally form as one piece. Additionally, the base is formed with one side of the housing.

In summary, a battery module in accordance with the present invention can effectively conduct and dissipate the waste heat produced from flat cells with the configuration that the flat cells are disposed on the thermally conductive plates. Additionally, the heat of the thermally conductive plates can further aggregate and then conduct it to outside thermally conductive plates with thermally conductive cylinders connecting thermally conductive plates by conduction. When air flow passes through the battery module and thereby contacts with the thermal exchange plates, the thermal exchange can be achieved for balancing the whole temperature of the battery module. Importantly, since the thermally conductive plates fix the flat cells simultaneously, it can integrate the thermal dissipation system and the fixing structure together for reducing the size of the battery module efficiently.

In addition, since the insulating fixing unit is configured, the electrodes and the cell bodies of the flat cells can be fixed on an identical surface. The stiffness of the flat cell can be improved. Moreover, because the electrodes are fixed on the fixing unit with extra lengths, it provides cushion space to counteract the pulling force and prolong the life time of the battery module. It also can enhance security by preventing the flat cells from directly contacting with cooling air. Additionally, the improved fixing configuration of the electrodes and the cell bodies is advantageous for the whole battery module to absorb the impact force. It prevents the electrode breakage caused by excess pulling force and enhances the security of the battery module when the battery module is against vibration.

### BRIEF DESCRIPTION OF THE DRAWINGS

The invention will become more fully understood from the detailed description and accompanying drawings, which are given for illustration only, and thus are not limitative of the present invention, and wherein:

FIG. 1 is a laterally cross-sectional figure of the battery module in accordance with the first preferred embodiment of the present invention;

FIG. 2 is a laterally cross-sectional figure of the battery module in accordance with another aspect of the first preferred embodiment of the present invention;

FIG. 3 is a schematic figure illustrating the appearance of the battery module shown in FIG. 1;

FIG. 4A is a schematic figure illustrating the battery module shown in FIG. 1 without certain parts of the housing;

FIG. 4B is the enlarged schematic figure illustrating the fixing unit of the battery module shown in FIG. 4A.

FIG. 5A is a schematic illustrating a battery module in accordance with the second preferred embodiment of the present invention without a housing; and

FIG. 5B is a laterally cross-sectional figure of the battery module shown in FIG. 5A.

### DETAILED DESCRIPTION OF THE INVENTION

The present invention will be apparent from the following detailed description, which proceeds with reference to the accompanying drawings, wherein the same references relate to the same elements.

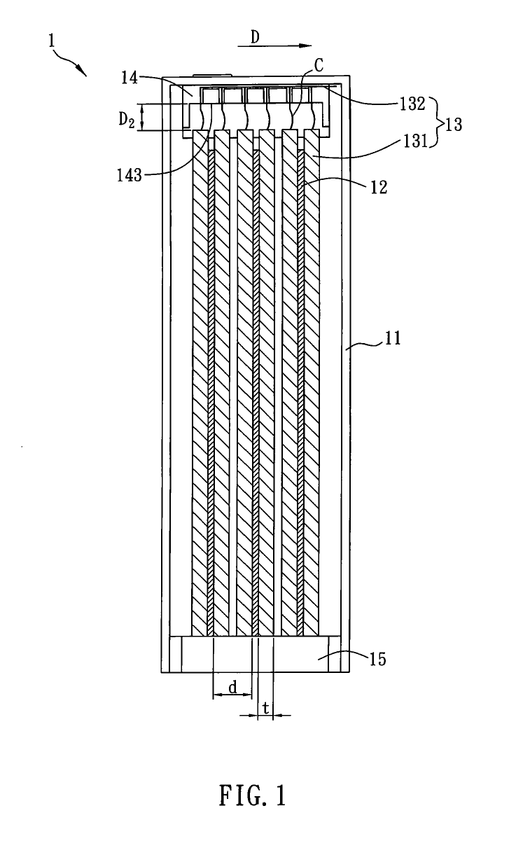

FIG. 1 is a laterally cross-sectional figure of a battery module of the first preferred embodiment in accordance with the present invention. As shown in FIG. 1, the battery module 1 of the present embodiment includes a housing 11, a plurality of thermally conductive plates 12, a plurality of flat cells 13 and a fixing unit 14. The thermally conductive plates 12, the flat cells 13 and the fixing unit 14 are received in the housing 11. The battery module 1 can be applied in a vehicle. In a vehicle, a plenty of the battery modules is assembled into a battery stack for charging or discharging. The flat cells 13 in accordance with the present invention are preferably plate-type lithium cells. However, plate-type cells made from other materials can be used as well. The housing 11 is preferably an insulating housing.

The thermally conductive plates 12 are disposed along a direction D and parallel to each other. The term “parallel” used herein is intended to mean an alignment which objects are completely parallel or not completely parallel with an error caused by defects and unavoidable factors in manufacturing. The thermally conductive plates 12 can be fixed on an insulating plastic base 15 to maintain their positions. Alternatively, the thermally conductive plates 12 can be fixed directly on for example but not limited to a side of the inner surface of the housing 11. In the present embodiment, the thermally conductive plates 12 are thermally conductive metal plates made of highly thermally conductive material.

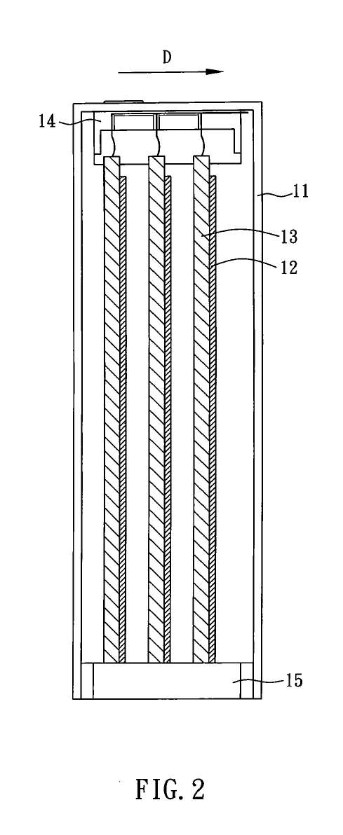

Each of the flat cells 13 includes a cell body 131 and two electrodes 132 connected to and extended from the cell body 131, respectively. The flat cells 13 have to contact with the thermally conductive plates 12 to conduct and then dissipate the heat. As shown in FIG. 1, at least one of the thermally conductive plates 12 is disposed between two of the flat cells 13 and contacts with at least one of the two flat cells 13 in the configuration of the battery module in accordance with the present invention. In the present embodiment, one of the thermally conductive plates 12 is disposed between two of the flat cells 13 and contacts with both of them simultaneously. In other words, the two flat cells 13 are disposed at different sides of the thermally conductive plate 12, respectively. However, as shown in FIG. 2, in another aspect of the present embodiment, one of the thermally conductive plates 12 is disposed between two of the flat cells 13 but only contacts with the flat cell on the right along the direction D. The other contacts with another thermally conductive plate 12 (as the next thermally conductive plate 12 shown in FIG. 1). In addition, each of the flat cells 13 is disposed at the same side of the thermally conductive plate 12 (i.e. the right side along the direction D), respectively. Specifically, the flat cells 13 are substantially parallel to the thermally conductive plate 12 and a surface of the flat cell 13 is fattened against the thermally conductive plate 12.

To be noted, with regard to the configuration of the thermally conductive plates 12 and the flat cells 13, a distance d is kept between two of the thermally conductive plates and half of the distance d/2 is at least greater than a thickness t of the flat cells 13. As shown in FIG. 1, in the present embodiment, the distance d between two of the thermally conductive plates 12 is two times greater the thickness of the flat cell 13 (t referring to the thickness of each of flat cell). In other words, a single flat cell 13 does not contact with two adjacent thermally conductive plates simultaneously so as to allow a space for swelling.

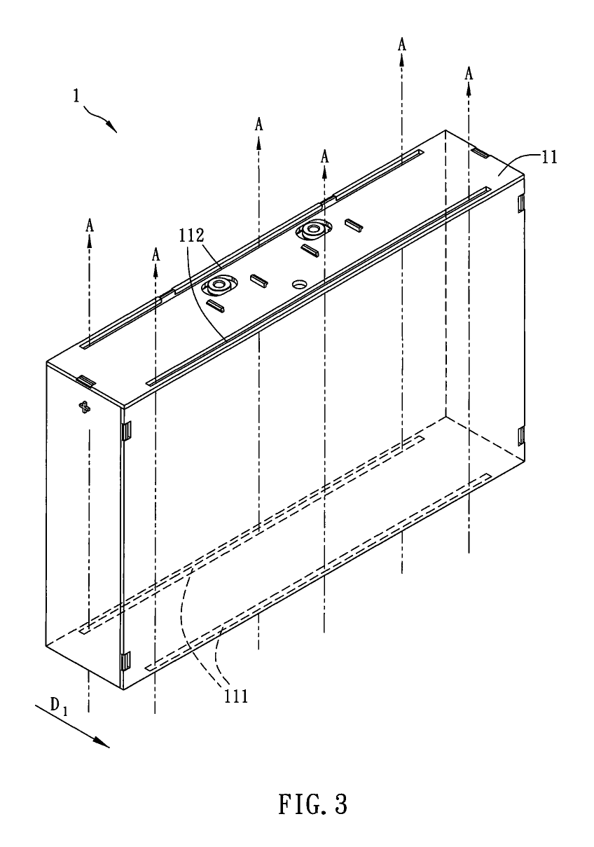

FIG. 3 is a schematic figure illustrating the appearance of the battery module shown in FIG. 1. As shown in FIGS. 1 and 2, in the present embodiment, the housing 11 is made of an insulating material and, preferably, made of plastic. Along a direction D1, inlets 111 are disposed at the front side and the back side of the bottom of the housing 11, respectively, and outlets 112 are disposed at the top of the housing 11 corresponding the inlets. Channels for air flow are formed between the inlets 111 and the outlet 112 (as a direction A of air flow shown in FIG. 3). Accordingly, the flat cells 13 can achieve heat balance with the thermally conductive plates 12 so as to conduct and dissipate the waste heat. Sequentially, the waste heat is carried out to complete thermal dissipation by the convection generated by an air flow flowing through the battery module 1 from the inlets to the outlet.

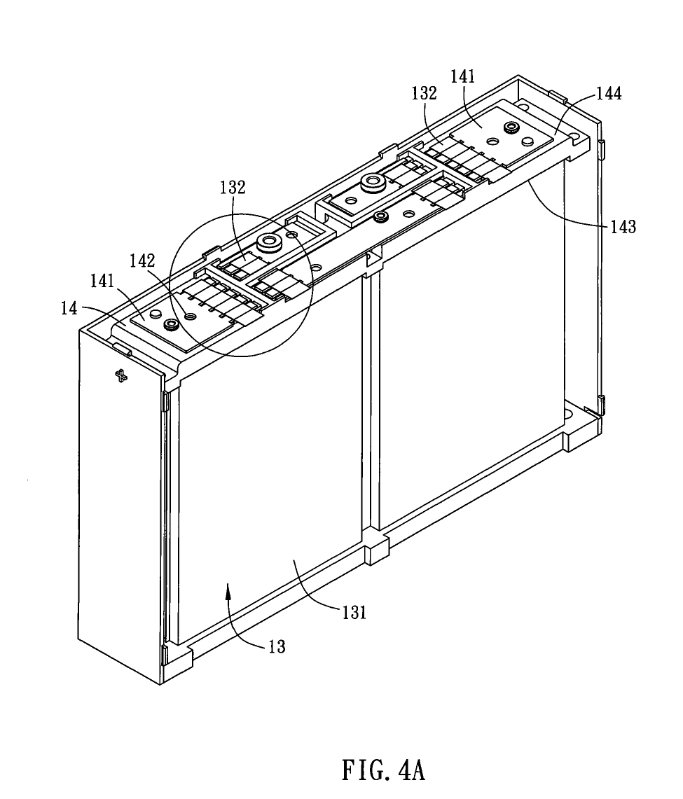

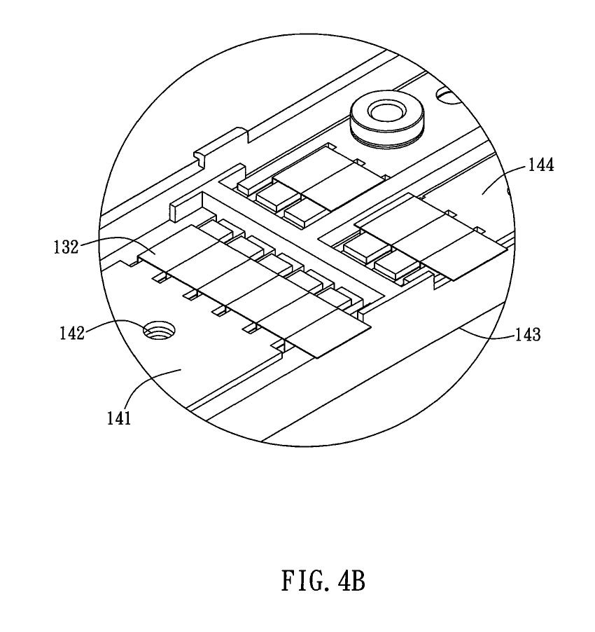

FIG. 4A is a schematic figure illustrating the battery module shown in FIG. 1 without certain parts of the housing, and FIG. 4B is the enlarged schematic figure illustrating the fixing unit of the battery module shown in FIG. 4A. As shown in FIGS. 4A and 4B, in the present embodiment, the fixing unit 14 is an insulating component, and a plurality of electrically conductive materials 141 is disposed on a surface of an end of the fixing unit for fixing the electrodes 132 of the flat cells 13. Preferably, the electrically conductive materials 141 can have high electrical conductivity. A plurality of threaded holes 142 is disposed on the electrically conductive material 141 for further locking on the fixing unit 14. Consequentially, it can simultaneously fix the electrodes 132 and collect the electric energy of the flat cells 13 for integral output. In more detailed, the electrodes 132 are passed through the fixing unit 14 from one side 143 of the fixing unit 14 adjacent to the cell bodies 131 and then fixed on the electrically conductive materials 141 on the other side 144 of the fixing unit 14 opposite to the cell bodies 131. The electrodes 132 can be fixed on the electrically conductive materials 141 by for example welding. Additionally, in another aspect of the present embodiment, the thermally conductive materials 141 can be integrated into a single piece or few pieces for fixing the electrodes 132 appropriately.

As shown in FIG. 1, in the present embodiment, the electrodes 132 between a side 143 of the fixing unit 14 and the cell bodies 131 are longer than distances D2 between the fixing unit 14 and the cell bodies 131. In other words, the electrodes 132 between the fixing unit 14 and the cell bodies 131 are flexible rather than stretched. The extra parts of the electrodes 132 with respect to the distances D2 can form for example but not limited to wave shape or bending figure.

Accordingly, because the electrodes are fixed on the electrically conductive materials fixed on the fixing unit by low temperature process such as spot welding, ultrasonic welding, laser welding and friction welding and so on, it is advantageous to decrease the degree of the relative motion between the electrodes and the cell bodies and reduce the risk of the electrode breakage caused by an external pulling force when the battery module is impacted or vibrated. Moreover, the reserved length of the electrodes between the fixing unit and the cell bodies can partially counteract the external pulling force to prolong the life time of the battery pack.

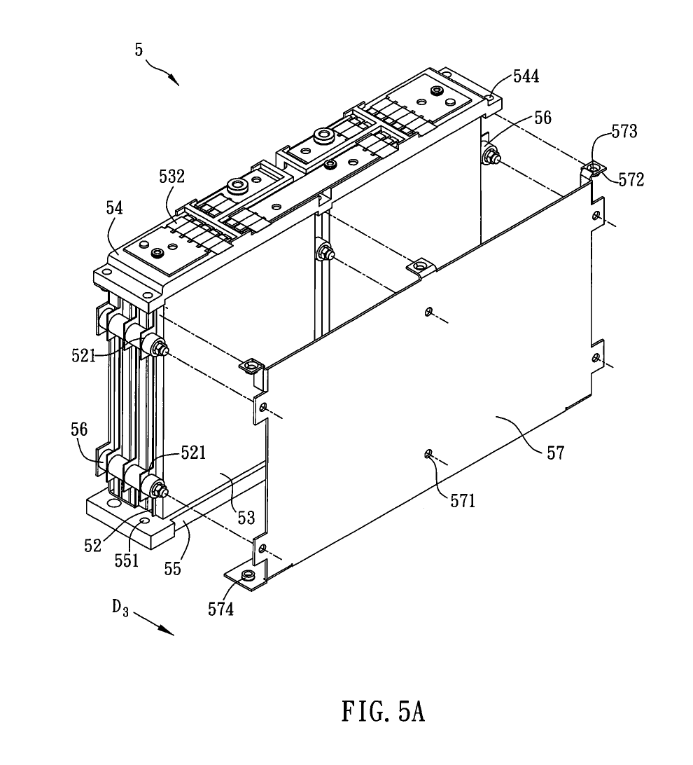

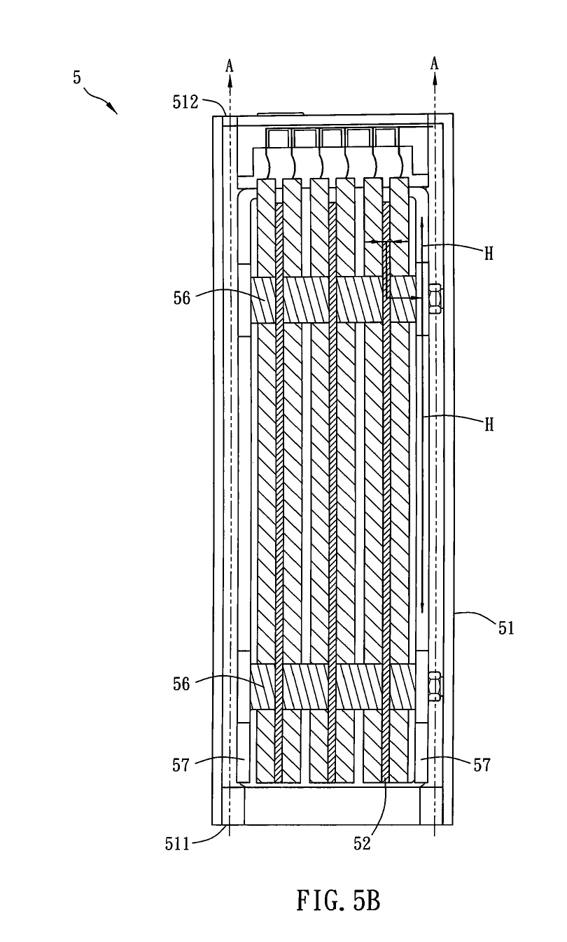

FIG. 5A is a schematic figure illustrating a battery module in accordance with the second preferred embodiment of the present invention without a housing, and FIG. 5B is a laterally cross-sectional figure of the battery module in accordance with the second preferred embodiment of the present invention. In the second embodiment of the present invention, the configuration and the technical characteristics of the battery module are substantially the same with the battery module in the first preferred embodiment of the present invention except that the battery module further includes at least a thermally conductive cylinder 56 and at least a thermal exchange plate 57. As shown in FIG. 5A, in the present embodiment, the thermal exchange plate 57 is disposed along a vertical direction of the thermally conductive plates 52 and contacts with the thermally conductive cylinder 56 such that one of the flat cells 53, one of the thermally conductive plate 57 and the thermally exchange plate 57 form a sandwich assembly. Also as shown in FIG. 5A, in the present embodiment, the battery module 5 includes six thermally conductive cylinders 56 and two thermal exchange plates 57. The thermally conductive cylinders 56 are made of thermally conductive metals and, preferably, are made of cupper or aluminum. The materials of the thermal exchange plates 57 and the thermally conductive plates 52 can be the same or different in the present embodiment. However, the thickness of the thermal exchange plates 57 is thicker than that of the thermally conductive plates 52. Preferably, the thermal exchange plates 57 are made of a thermally conductive metal identical with the material of the thermally conductive plates 52. Additionally, in the present embodiment, the distance between two of the thermally conductive plates 52 depends on the height of the thermally conductive cylinders 56, and sufficient space is reserved between two adjacent flat cells for swelling.

As shown in FIG. 5A, in the present embodiment, the thermally conductive cylinders 56 are received in the housing and contact with the thermally conductive plates 52 by studs of the thermally conductive cylinders passing through holes 521 on the two sides of the thermally conductive plates 52, especially the thermally conductive plates contacting with the flat cells 53. The thermal exchange plates 57 are disposed at the two opposite outer sides of the thermally conductive plates 52 along a direction D3. Similarly, the thermal exchange plates contact with the thermally conductive cylinders 56 partially. For example, tapped holes 571 can be formed on the thermal exchange plates 52 to fix the thermal exchange plates 57, the thermally conductive plates 52 and the thermally conductive cylinders 56 together by screwing. Preferably, the thermally conductive cylinders 56 are locked on a surface of the thermal exchange plate 57. Besides screwing, other fixing ways to apply a compact force on the outer sides of the thermal exchange plates 57 to maintain the close contact between the flat cells 53, the thermally conductive plates 52, the thermally conductive cylinders 56 and the thermal exchange plates 57 can be used as well. It is advantageous for fixing the battery module 5 and improving the efficiency of heat dissipation.

As shown in FIG. 5A, in the present embodiment, the thermally conductive plates 52, the thermal exchange plates 57, the fixing unit 34 and the base 55 are fixed together to form integrally as one piece. In more detailed, the thermally conductive plates 52, the fixing unit 54 and the base 55 are integrally fixed on the thermal exchange plates 57 at two outer sides as one piece. A protrusion part 572 is formed at an end of the thermal exchange plates 57 adjacent to the fixing unit 54. Moreover, threaded holes 573 and 544 formed on the protrusion part 572 and the fixing unit 54 respectively can be used for fixing the protrusion part 572 and the fixing unit 54 together by screwing. Similarly, threaded holes 574 and 551 formed at an end of the thermal exchange plate 57 adjacent to the base 55 and on the bass 55 respectively can be used to fix the thermal exchange plate 57 on the base 55. Then, the base 55 can be further fixed on an inner side of the housing 51 to maintain the position of every major component of the battery module 5. Therefore, when the battery module is impacted or vibrated, the displacement between the flat cells 53 and the fixing unit 54 can be reduced such that it prevents the electrodes 532 between the flat cells 53 and the fixing unit 54 from breakage.

As shown in FIG. 5B, the thermally conductive plates 52, the thermally conductive cylinders 56 and the thermal exchange plates 57 can function thermally conductivity and contact with each other such that the heat produced by the flat cells 53 can be conducted to the thermally conductive cylinders 56 through the thermally conductive plates 52. After the heat from individual thermally conductive plate 52 is aggregated on the thermally conductive cylinders 56, it can be further conducted to the thermal exchange plates 57 (as the conduction path of the heat H shown in FIG. 5B). Since the inlets 511 and the outlets 512 are disposed on the housing and the channels of air flow access to the thermal exchange plates 57, the air flow can pass through the battery module 5 from the inlets 511 to the outlets 512 (as the direction of air flow A shown in the FIG. 5B) and, meanwhile, contacts with the thermal exchange plates 57 to dissipate the heat aggregated on the thermal exchange plates 57 for keeping the internal heat balance of the battery module 5.

In summary, a battery module in accordance with the present invention can effectively conduct and dissipate the waste heat produced from flat cells with the configuration that the flat cells are disposed on the thermally conductive plates. Additionally, the heat of the thermally conductive plates can further aggregate and then conduct it to outside thermally conductive plates with thermally conductive cylinders connecting thermally conductive plates by conduction. When air flow passes through the battery module and thereby contact with the thermal exchange plates, the thermal exchange can be achieved for balancing the whole temperature of the battery module. Importantly, since the thermally conductive plates fix the flat cells simultaneously, it can integrate the thermal dissipation system and the fixing structure together for reducing the size of the battery module efficiently.

In addition, since the insulating fixing unit is configured, the electrodes and the cell bodies of the flat cells can be fixed on an identical surface. The stiffness of the flat cell can be improved. Moreover, because the electrodes are fixed on the fixing unit with extra lengths, it provides cushion space to counteract the pulling force and prolong the life time of the battery module. It also can prevent the flat cells from directly contacting with cooling air so as to enhance security. Additionally, the improved fixing configuration of the electrodes and the cell bodies is benefit for the whole battery module to absorb the impact force. It prevents the electrode breakage caused by excess pulling force and enhances the security of the battery module when the battery module is against vibration.

Comparing with battery module in the prior art, the battery module in accordance with the present invention has no need to configure particular channels for air flow in the battery module such that it improves space utilization for increasing the amount of the battery modules disposed in the limited space of a vehicle. Moreover, it also reduces the lock points efficiently and enhances security by preventing the flat cells from directly contacting with cooling air. Additionally, the improved fixing configuration of the electrodes and the cell bodies is advantageous for the whole battery module to absorb the impact force. It prevents the electrode breakage caused by excess pulling force and enhances the security of the battery module when the battery module is against vibration.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A battery module, comprising:
a housing;
a plurality of thermally conductive plates received in the housing;
a plurality of flat cells received in the housing, wherein at least one of the thermally conductive plates is disposed between two of the flat cells and contacts with at least one of the two of the flat cells, each of the flat cells respectively has a cell body and at least an electrode connected to and extended from the cell body; and
a fixing unit received in the housing wherein the electrode is fixed on the fixing unit.

2. The battery module according to claim 1, wherein the other one of the two of the flat cells contacts with another thermally conductive plate.

3. The battery module according to claim 1, wherein the two of the flat cells are disposed at the same side or at different sides of the thermally conductive plate.

4. The battery module according to claim 1, wherein a surface of the flat cell is fattened against the thermally conductive plate.

5. The battery module according to claim 1, wherein the thermally conductive plates are disposed along a direction and a distance between two of the thermally conductive plates is at least greater than the thickness of the flat cell.

6. The battery module according to claim 1, wherein the electrodes between the fixing unit and the cell bodies are longer than distances between the fixing unit and the cell bodies.

7. The battery module according to claim 6, wherein the extra parts of the electrodes with respect to the distances form wave shape or bending feature.

8. The battery module according to claim 1, wherein the electrodes are passed through the fixing unit from one side of the fixing unit adjacent to the cell bodies and then fixed on the other side of the fixing unit with respect to the cell bodies.

9. The battery module according to claim 1, wherein the fixing unit comprises at least an electrically conductive material and the electrodes are fixed on the fixing unit by being fixed on the electrically conductive materials.

10. The battery module according to claim 1, wherein the housing has at least an inlet and an outlet and an air flow flows through the battery module from the inlet to the outlet.

11. The battery module according to claim 1, further comprising:
at least a thermally conductive cylinder received in the housing and contacting to the thermally conductive plates contacting with the flat cells.

12. The battery module according to claim 11, wherein the thermally conductive cylinders contact with the thermally conductive plates by studs of the thermally conductive cylinders passing through holes of the thermally conductive plates.

13. The battery module according to claim 12, further comprising:
at least a thermal exchange plate disposed along a vertical direction of the thermally conductive plates and contacting with the thermally conductive cylinder such that the one of the flat cells, one of the thermally conductive plate and form a sandwich assembly.

14. The battery module according to claim 13, wherein the thermally conductive cylinder is locked on a side of the heat exchange plate.

15. The battery module according to claim 13, comprising two of the heat exchange plates disposed at two opposite sides of the thermally conductive plates along the direction.

16. The battery module according to claim 15, wherein the housing has at least an inlet and an outlet and an air flow passing through the heat exchange plates when passing through the battery module from the inlet to the outlet.

17. The battery module according to claim 13, further comprising:
a base on which the thermal exchange plate is fixed.

18. The battery module according to claim 17, wherein the thermally conductive plates, the heat exchange plates, the fixing unit and the base are fixed together to integrally form as one piece.

19. The battery module according to claim 18, wherein the base is formed with one side of the housing.
